(19) United States
(12) Patent Application Publication
(10) Pub. No.: US 2017/0358000 A1
(43) Pub. Date: Dec. 14, 2017

(54) INTRADAY MODELING TO ADJUST ONLINE AD DISTRIBUTION

(71) Applicant: ADOBE SYSTEMS INCORPORATED, San Jose, CA (US)

(72) Inventors: Kunal Kumar JAIN, Chennai (IN); Satheeshkumar MOHAN, Bengaluru (IN); Arava Sai KUMAR, San Jose, CA (US)

(21) Appl. No.: 15/179,719

(22) Filed: Jun. 10, 2016

(51) Int. Cl. G06Q 30/02

(52) U.S. Cl. CPC G06Q 30/0244; G06Q 30/0249; G06Q 30/0246; G06Q 30/0247; G06Q 30/0275

(57) ABSTRACT

Systems and methods for distributing online ads with electronic content according to a campaign strategy that is adjusted based on intraday modeling. One embodiment of the invention determines a campaign strategy for a current day allocating a daily budget to automatically bid on online ad opportunities using allocated budget amounts and distributes online ads during a first portion of the current day according to the campaign strategy. Current day data regarding use of the distributed online ads during the first portion of the current day is received and compared with historical data to determine a correction factor that accounts for a magnitude of difference between the current day data and the historical data. The campaign strategy for the current day is adjusted using the correction factor and additional online ads are distributed during a second, later portion of the current day according to the adjusted campaign strategy.

### TECHNICAL FIELD

This disclosure relates generally to computer-implemented methods and systems and more particularly relates to improving the efficiency and effectiveness of computing systems used to manage and distribute online ads.

### BACKGROUND

Computer users run web browsers, search engines, social media applications, and other computer tools to access electronic content that is available through the Internet. Such content is often provided along with targeted promotional materials. In one example, a user is presented with an online ad for a retail item when the user accesses a particular webpage or initiates a keyword-based search engine search using a particular keyword. The online ad is often targeted, for example, having been selected based on the content of the webpage, the keyword, and/or the user's identity or other user information, e.g., based on an item on a wish list associated with the user's online shopping account with an online retailer. Marketers pay for these targeted and non-targeted promotional opportunities and employ sophisticated computer applications (i.e., electronic marketing optimization systems) to improve their return on investment (ROI) by selecting where to place online ads and how much to pay for the placement of the online ads, e.g., how to bid for placement of online ads on websites, on social media, and based on search engine keywords, etc.

Electronic marketing optimization systems used to help marketers use online ad budgets efficiently must address several challenges specific to the context of the Internet. Unlike in the context of paper-based advertising in which processes occur slowly over the course of days, weeks, and months, in the context of the Internet, electronic online ads are sent, received, acted upon, and the responses tracked and analyzed within hours, minutes, or even seconds. As a result, same day information about the success or failure of the various aspects of a campaign and the changing environment in which the campaign is implemented is potentially available, but generally not adequately accounted for, in optimizing and implementing marketing strategies

Existing electronic marketing optimization systems use models to create predictions for campaigns and then use those predictions to create and implement particular strategies for the campaigns. The systems' predictions predict, for example, the costs of advertising and the expected resulting click events, transactions, orders, and other conversions. The predictions and strategies are periodically created but are generally not created more than once a day because of the computational complexity of the determinations, among other reasons. Daily strategies are based on daily (or less frequent) predictions and fail to adequately adapt to events that happen during each day. For example, in Search Engine Marketing (SEM), a marketer wishes to optimize ROI through effective bid management of keywords. The marketer uses a conventional system that optimizes bids using estimates of the cost of keywords and expected clicks for the current day, for example, based on the historical data/performance of a given keyword excluding the current day. Generally, the system does not account for intraday occurrences. Intraday adjustments, if made at all, are based on fixed percentage adjustments. For example, if spending during a first part of the current day for a particular campaign is higher than expected for the day's budget, then all the bids of the campaign are decreased by a fixed percentage, e.g., 20%. Conversely, if spending for the first part of the current day for the particular campaign is lower than expected for the day's budget, then all the bids of the campaign are increased by the fixed percentage. This strategy is not optimal as all the keywords are not similar and hence, some keywords should have their bids decreased or increased more compared to others based on their individual ROIs. Thus, the conventional approach either does not account for intraday data or does so in a way that is overly simplistic and inefficient since bids are increased or decreased by fixed amounts irrespective of how much the actual day differs from history-based expectations for the day and keyword differences. The campaign's budget is not reallocated effectively based on intraday data. In addition to failing to adequately adapt to events that happen during each day, existing systems also do not account for portfolio budget changes and portfolio composition changes and thus do not quickly respond to the marketer's changing desires and requirements.

### SUMMARY

Systems and methods are disclosed herein for distributing online ads with electronic content according to a campaign strategy that is adjusted based on intraday modeling. One embodiment of the invention determines a campaign strategy for a current day allocating a daily budget to automatically bid on online ad opportunities for the online ads using allocated budget amounts and distributes online ads with electronic content during an early portion of the current day according to the campaign strategy for the current day. Current day data regarding use of the distributed online ads during the early portion of the current day is received and compared with historical data to determine an intraday correction factor that accounts for a magnitude of difference between the current day data and the historical data. The campaign strategy for the current day is adjusted using the correction factor and additional online ads are distributed with electronic content during a second, later portion of the current day according to the adjusted campaign strategy for the current day.

Another embodiment automatically bids on online ad opportunities to distribute online ads with electronic content during an early portion of a current day according to a campaign strategy for the current day. Current day data regarding campaign-level click and cost trends for the early portion of the current day is received and used to adjust the campaign strategy at a more granular level for the current day. Additional online ads are then distributed with electronic content during a second, later portion of the current day according to the adjusted campaign strategy for the current day.

These illustrative features are mentioned not to limit or define the disclosure, but to provide examples to aid understanding thereof. Additional embodiments are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings.

FIG. 1 illustrates an exemplary general process for intraday adjusting of a campaign strategy.

FIG. 2 illustrates an exemplary relationship between an intraday adjustment and a daily cycle.

FIG. 3 illustrates an exemplary computer network environment in which an exemplary system provides intraday adjusting.

FIG. 4 illustrates an exemplary timeline illustrating daily and intraday adjustment.

FIG. 5 illustrates another exemplary timeline illustrating intraday adjustment.

FIG. 6 is a flow chart illustrating an exemplary method for an intraday campaign strategy adjustment.

FIG. 7 is a flow chart illustrating an exemplary method for distributing online ads according to an intraday campaign strategy adjustment.

FIG. 8 is a block diagram depicting an example hardware implementation.

### DETAILED DESCRIPTION

As discussed above, existing electronic marketing optimization systems create and implement marketing strategies using day-to-day predictions and fail to adequately adapt to events and portfolio changes that happen during each day. The invention provides improved electronic marketing optimization systems that use the current day's early data to adjust the current day's predictions and then re-optimize the marketing strategy regarding how to spend the day's budget based on the adjusted predictions. The current day's early data, such as data about number of clicks and cost per click so far that day, is used to correct the prediction estimates for the day and the marketing strategy is adjusted to improve spend accuracy and ROI. This technique is advantageous over the existing technique that adjusts all aspects by a fixed percentage because this technique accounts for the magnitudes of the differences in actual versus expected values and thus responds to actual conditions more accurately. Moreover, this technique reallocates the day's budget to provide a more appropriate adjustment to the day's marketing strategy without necessarily having to recalculate the entire strategy anew, which would be computationally undesirable in many implementations. In addition, the re-optimization accounts for any changes in the portfolio made by the marketer, such as a change that would double the day's total budget, so that the marketer's changes are implemented during the current day rather than waiting for future days for implementation.

An exemplary system illustrating one possible implementation of the invention determines a correction factor and then re-optimizes a campaign strategy for the rest of the day using the correction factor. In this example, the correction factor is determined using campaign-level daily data, such as click and cost per click trends, as a proxy for online ad-level trends. The system fetches hourly campaign data for the day up to the current time and also uses historical trend data. The correction factor is determined based on the difference between the current trend and historical trend, for example, based on the difference between the cost per click expected by 8:00 am on a typical day using historical data and the actual cost per click achieved by 8:00 am on the current day. In one example, the difference between the current trend and the historical trend at any given hour is captured as the ratio of the current trend and the historical trend at that hour. This campaign correction factor for one or more hours or combined for the entire day so far is used to correct the prediction model for all the keywords of the campaign. For example, the system adjusts the campaign strategy by optimizing use of the remaining budget for appropriate online ad opportunities (e.g., different keyword bids, webpage ad locations, or social media ad locations, etc.) based on the correction factor.

In one implementation adjusting the strategy involves changing keyword bids and online ad location selections to maximize ROI. For example, the system prioritizes increasing the bid of keyword 1 over increasing the bid of keyword 2 based on an estimate that increasing the bid on keyword 1 will result in more of an ROI increase than increasing the bid on keyword 2.

The following example illustrates use of a correction factor to re-optimize a campaign strategy during the day. In this example, the campaign strategy for the current day is determined prior using a model based on historical data. The model predicts various outcomes for various potential spending activities based on historical data. For example, the model predicts bidding on keyword 1 at a bid price of $0.05 will result in purchase of 1000 online ad placements, will result in spend of $50, and will result in 500 clicks, and thus yield an expected cost per click of $0.10 ($50/500 clicks), the model predicts that bidding on keyword 1 at a bid price of $0.10 will result in purchase of 1600 online ad placements, will result in spend of $160, and will result in 800 clicks, and thus yield an expected cost per click of $0.20 ($160/800), etc. The system uses the model to determine the campaign strategy for the current day before the current day begins. In illustrated example, the system determines that the $100 total current day budget is to be spent by bidding $0.05 on keyword 1 (“smart phone”) and $0.05 on keyword 2 (“mobile phone”). Based on the model, the system expects to spend $50, place 1000 online ads, and receive 500 clicks by noon ($0.10 cost per click) and then spend another $50, place another 1000 online ads, and receive another 500 clicks after noon ($0.10 cost per click). The system thus expects to spend the entire $100 budget for the current day on online ads placed by bidding on keyword 1 and keyword 2.

The system uses actual results during the current day to adjust the campaign strategy. In this example, by noon the campaign (i.e., both keywords) achieves an actual cost per click of $0.20 instead of the expected $0.10. Moreover, the budget was not spent as expected, with only $25 instead of the expected $50 of the campaign budget having been spent before noon. The system uses these campaign level intraday data points to adjust the campaign strategy for the rest of the day, i.e., for the afternoon. Specifically, the campaign strategy is adjusted to spend $75 in the afternoon rather than the planned $50 and to account for the higher than expected cost per click. In this example, the correction factor is determined by dividing the campaign actual cost per click ($0.20) by the campaign predicted cost per click ($0.10) to give a correction factor of 2.

The model is adjusted using the cost per click correction factor so that the cost per click values are adjusted accordingly. In this example, the adjusted model predicts that bidding on keyword 1 at a bid price of $0.05 yield an expected cost per click of $0.20 ($0.10*2), that bidding on keyword 1 at a bid price of $0.10 will yield an expected cost per click of $0.40 ($0.20*2), etc. The adjusted model is then used to determine how to spend the $75 remaining in the daily budget for the afternoon. Specifically, an appropriate combination of spending activities based on the adjusted values in the model to achieve a desired outcome such as maximizing clicks, ROI, etc. In this example, the system could determine, based on the adjusted model, that bidding $0.8 on keyword 1 is expected to spend $40 and bidding $0.7 on keyword 2 is expected to spend the remaining $35 ($75-$40) based on determining that this combination provides the most total number of conversions of all of the permutations of spending on keyword 1 and keyword 2 bids modelled by the adjusted model. In this simple example, only two spending activities at varying bidding levels were described. In practice, the model will generally represent numerous spending activities and spending activities of different types, e.g., different keyword bids, webpage ad locations, social media ad locations, etc. In this example, the system is able to compute a correction factor that accounts for the magnitudes of the differences in actual versus expected values and thus respond to actual conditions during the day to adjust the campaign strategy.

Certain implementations of the invention provide electronic marketing optimization systems that react to information on hourly campaign data, campaign composition and portfolio budgets during each day to correct prediction estimates and improve spend and click accuracy while also improving ROI. Certain implementations use a boosting approach that combines historical data and current day data to correct prediction estimates to quickly react to unexpected daily circumstances such as changing cost per click (CPC), click trends, campaign compositions and budgets. For example, during holidays which have larger-than-ordinary budgets and frequent budget changes, CPC and cost estimates vary significantly and hourly campaign data is a reliable source to identify new trends. Certain implementations of the invention provide electronic marketing optimization systems that are able to respond quickly and appropriately to such trends.

As used herein, the phrase “online ad” refers to an item that promotes an idea, product, or service and that is provided electronically in or with a web page, e-mail, or other electronic communication sent, accessed by, or made available to one or more individuals through a computer network such as the Internet. Examples of online ads include, but are not limited to, images, text, graphics, sound, and/or video incorporated into a web page, search engine result, or social media content on a social media app or web page that advertise or otherwise promote or sell something, usually a business's products or services.

As used herein, the phrase “electronic content” refers to any content in an electronic communication such as a web page or e-mail accessed by, or made available to, one or more individuals through a computer network such as the Internet. Examples of electronic content include, but are not limited to, images, text, graphics, sound, and/or video incorporated into a web page, search engine result, or social media content on a social media app or web page.

As used herein the phrase “campaign strategy” refers to is a proposed pathway of objectives, tasks, or other parameters to achieve a marketing objective. An example of a campaign strategy identifies a promotion, a daily budget for the promotion, one or more advertisements associated with the promotion, and one or more opportunities for providing the ads such as search engine keyword bid opportunities, web page ad display opportunities, and social media ad display opportunities.

As used herein, the phrase “current day” refers to a single day or other period of less than or equal to a set amount of time, usually 24 hours. Calculations performed for a “current” day can occur prior to the current day. For example, around the end of one day (e.g., at 10:00 pm), a campaign strategy for the next “current” day can be determined to essentially determine the campaign values for tomorrow. The phrases “first portion” and “early portion” of the current day refer to any increment of time occurring during the current day prior to a “second portion” or “later portion” of any increment of time. An early portion of the current day can be, but need not be, of the same time length as an early portion of the current day. In one embodiment of the invention, time zone changes result in a current day of more than 24 hours.

As used herein, the phrase “daily budget” refers to an amount of money allocated for a day. In one example, a daily budget allocates different amounts of money from an advertising campaign to bid on one or more opportunities for providing online ads of the ad campaign such as search engine keyword bid opportunities, web page ad display opportunities, and social media ad display opportunities.

As used herein, the phrase “search advertising” refers to a method of placing online ads on web pages that show results from search engine queries. A keyword-based search engine provides online ad opportunities for marketers to place online ads on the webpage the provides the keyword-based search engine search results.

As used herein, the phrase “bid” refers to an offer to pay for a search, webpage, or social media online ad opportunity. Bids are used to place online ads in display advertising, search advertising, and social media advertising. The phrase “keyword bid” refers herein to an offer to pay to have an online ad provided by a search engine in search results that are provided in response to a search engine search in keyword-based search engine advertising. Keyword-based search engine advertising is sold and delivered on the basis of keywords. An individual uses a search engine input website to enter keywords to make queries that search online sources such as Internet webpages and online databases for search results. A “keyword” is one or more words. Several keyword-based search engines conduct running auctions to sell online ads according to bids received for keywords and relevance to online ads. In display advertising, an online ad (e.g., an image, text, audio, and/or video) is provided along with web page content in response to requests from one or more individuals for the web page. For example, a banner ad location on a web page that is populated to display an online ad is an example of a web page location. Another example is an opportunity to provide a pop-up ad along with requested web page content. Another example is an opportunity to play audio along with requested web page content. In social media advertising, an online ad (e.g., an image, text, audio, and/or video) is provided along with social media content. An example is a location in a news feed for an online ad. Another example is a location within a series of shared content items from a given user or account, e.g., a location with a series of tweets.

As used herein, the phrase “individual” refers to a person, such a person who browses the Internet to display and interact with web pages, search engines, and social media content.

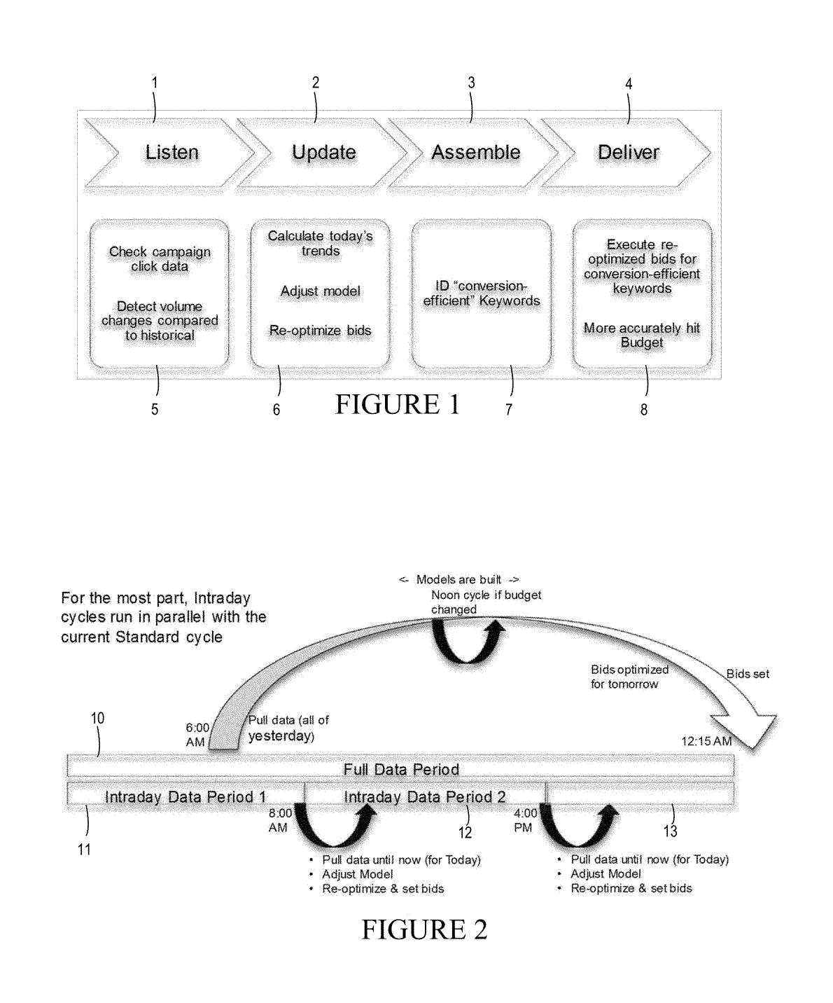

FIG. 1 illustrates an exemplary process for intraday adjusting of a campaign strategy. This exemplary process involves a listen step 1, an update step 2, an assemble step 3, and a deliver step 4. In the listen step 1, the process checks campaign click data and detects volume changes compared to historical expectations, as shown in block 5. In the above example, for the campaign, by noon the campaign (i.e., both keywords) achieved an actual cost per click of $0.20 instead of the expected $0.10. Moreover, the budget was not spent as expected, with only $25 instead of the expected $50 of the campaign budget spent before noon.

In the update step 2, the process calculates today's trends and adjusts the day's model accordingly, as shown in block 6. In the example described above, the campaign strategy is adjusted to spend $75 in the afternoon rather than the planned $50 and to account for the higher than expected cost per click. A correction factor is determined by comparing the campaign actual cost per click with the campaign predicted cost per click. In one example, the correction factor is a multiplier determined by dividing the campaign actual by the campaign predicted values. The correction factor is then used to adjust the current day's model to be used for the remainder of the current day to spend the $75 remaining in the daily budget. The adjusted model is then used to re-optimize bids to place on-line ads with electronic content.

In the assemble step 3, the process identifies conversion efficient keywords as shown in block 7. As described above, use of the model to change the campaign strategy can involve selecting an appropriate combination of spending activities based on the adjusted model. The system may determine to spend more on display advertising than on keyword bidding, to adjust bid values up or down, to add or change keywords to be bid on, etc. In the example of FIG. 1, the process selects keywords based on the expectations that bidding on the keywords will lead to conversions or other desired outcomes. More efficient keywords, according to the model, lead to more conversions or other desired activities.

In the deliver step 4, the process executes the re-optimized bids for the conversion efficient keywords, as shown in block 8. In this way, daily performance is generally improved and marketers are enabled to more accurately hit their budgets and otherwise improve the performance of their campaign strategy implementations.

FIG. 2 illustrates an exemplary relationship between an intraday adjustment and a daily cycle. In this example, the intraday cycle runs in parallel with the standard daily cycle. In this example, the full data period 10 for a current day corresponds to three intraday periods, 11, 12, 13. Other embodiments can of course involve of different and varying lengths and numbers. The standard daily cycle involves pulling data from the entire prior day around 6:00 AM and uses the data to build models that are used to optimize and set bids for the next day by around 12:15 am. In parallel with this daily process, the exemplary technique makes intraday adjustments following the first and second intraday periods 11, 12. Specifically, at 8:00 AM and at 4:00 AM, data is pulled for the current day up until the respective point in time, the model is adjusted, and the bids are re-optimized and set. Accordingly, during the second intraday data period 12, the system operates using bids based on the model adjusted using the data from the first intraday data period 11. Similarly, during the third intraday data period 13, the system operates using bids based on the model adjusted using the data from the second intraday data period 12.

Adjusting a daily model and the resulting bids during the intraday periods in this way provides numerous benefits. Daily models are based on expectations that do not always come to fruition. This means that the campaign is expecting things to happen during the current day that do not necessarily end up happening and, without intraday adjustment, would result in underspending, overspending, and other inefficient uses of the portfolio budget. Moreover, the portfolio budget and composition may also change and are accounted for by the intraday adjustments. Also, implementing one or more intraday adjustments on top of an existing daily-based process provides a convenient way to extend the capabilities of the existing daily-based framework.

In one embodiment, campaign level intraday data is used to make more granular adjustments. This is particularly useful, for example, when keyword-level or other specific data is not as easily accessible or manageable. For example, pulling keyword-level data daily for an intraday period can be difficult because the volume of data is often very large and running the models on the large volume of keyword-level data is computationally difficult. One approach to address this issue is to leverage campaign-level trends and propagate the trends to the keyword-level or other more-specific level to correct the current day's model. In one implementation, it is not feasible or efficient to rerun the entire daily model at multiple points during the day because of the large volume of data and/or the need to make adjustments quickly. Leveraging the campaign level data that aggregates keyword-level data, allows keyword specific trends to be approximated with sufficient accuracy to allow very beneficial adjustments to be made without requiring time and processing intensive re-computation of the entire daily process. The assumption that the trend of the keyword is similar to the trend of the campaign associated with it is often sufficiently accurate. This correlation between campaign-level trends and keyword-level trends allows an intraday adjustment implementation to make approximations of the keyword-level trends based on the campaign-level trends. Model predictions are adjusted using these trend predictions and then the adjusted model is used to re-optimize to get the new online ad bids for the remainder of the day, or until another intraday adjustment is made.

This process is illustrated by the following specific example. Alternative implementations are of course possible. In this example, the system searches campaign level data and compares the campaign-level data with the historical trend. As a particular example, the system identifies that by 8:00 AM around 30% of an entire day's spend is on average spent and that this value remains relatively constant across many days. Based on the spend around 30% by 8 am on average historically, the system assumes that there is a high probability that it will find about a 30% spend on the current day 8:00 AM. Thus, during the current day, the system compares the current day spend by 8:00 AM with this expectation.

In one embodiment of the invention, a campaign-level correction factor is determined based on campaign-level data and used to correct ad-level features. Thus, if the historical data shows that 30% is usually spent by 8:00 AM and less than that has been spent on the current day by 8:00 AM, then a campaign-level correction factor is determined. For example, campaign level adjustments to cost and click estimates are determined. This involves a simple approximation in one implementation using campaign actual divided by campaign predictor to result in a correction factor. The correction factor is then used to adjust the model's predictions, for example, by multiplying the campaign factor by the model's earlier predictions.

The adjusted model predictions are next used to adjust the day's campaign strategy. In one implementation this involves re-optimization for the rest of the day and for the rest of the day's budget since some of the original daily budget was already used in the earlier part of the day. The actual campaign spend is calculated to determine the budget for the rest of the day and the campaign strategy is re-optimized using the new predictions. In one implementation, the correction factor that is determined based on campaign-level data is used to adjust prediction estimates for particular online ads, for example, adjusting amounts for costs and clicks for particular bids. In this way, a correction calculated at the campaign-level is applied at the online ad-level. In this case, for each bid, the system multiplies the correction factor with the previous estimates for costs and clicks to determine improved approximations for the costs and clicks for the day. In the above example, the intraday adjustment involves two major steps, determining a correction factor based on campaign-level data and then re-optimizing a campaign strategy implementing ad-specific details using the determined correction factor. This two-step process balances data gathering and computational efficiency with accuracy.

In contrast to prior systems that crudely attempted intraday adjustments using fixed changes, some, but not necessarily all, implementations of the invention use intraday information to calculate a correction factor that reflects the magnitude of deviation of campaign level data from expectation and then uses that correction factor in a specific optimization that determines an adjusted campaign strategy, e.g., new values for the bids. Thus, the amount of correction varies depending on the online ads performance on the current day, resulting in generally better-performing adjustments to the campaign strategies that more intelligently redistribute the current day's remaining budget for greater expected return on investment (“ROI”). The current day's early data is used to adjust prediction estimates for the current day to thereby react to fast changing click and cost per click volumes and improve spend accuracy and ROI.

Examples of current day data used to make campaign adjustments include, but are not limited to, click (i.e., click volume) and cost-per-click (“CPC”) data. In one example, the system determines that with a particular current bid, the campaign has achieved a very low number of clicks in an early part of the current day and responds to that by increasing the bid or correcting (reducing) click estimates for the rest of the current day. Similarly, based on determining that CPC is very high or very low for an early part of the current day, the system extrapolates traffic for the rest of the day and responds by increasing or decreasing bids and reallocating the daily budget.

In these example, the system is able to more accurately estimate for click and CPC, and, based on this, able to improve spend accuracy and ROI for the rest of the current day. Because the system adjusts prediction estimates for each of the keywords to provide more accurate estimates of what each keyword will achieve, it is able to reallocate the daily budget during earlier parts of the current day so that there is enough time to achieve better results for the rest of the current day.

One implementation of the invention provides additional benefits by making post re-optimization determinations. For example, online ads are prioritized post re-optimization to limit the number of online ads being pushed so that the process can be completed efficiently and within time constraints. In this example, online ads are prioritized post optimization on the basis of their impact so that only bids that have significant impact on ROI are pushed. In one embodiment of the invention, the system determines a difference in ROI for each online ad, i.e., a difference between the ROI if the online ad's bid does not change and the ROI if the bid does change. The online ads are then prioritized accordingly. For example, the system determines, in one example, to push only the number of bids that contribute to at least 80% of the total cost difference.

One implementation of the invention integrates with an existing daily-based system by providing intraday information that is easily used by the existing daily-based system. For example, if the existing daily based system makes daily models using a single daily values, the intraday system can combine intraday data to provide single daily values. As a specific example, if the daily system uses a single daily effective bid and the intraday model used 3 different bid values during the day, a single value is determined using those 3 values for use by the daily system. In other words, the system calculates an effective bid from multiple intraday bids for the daily click model which takes a single bid for a day for each ad as input. It creates an aggregate bid. In one example, a weighted average is determined based on campaign traffic, e.g., if before 8:00 AM 20% of bids occur, between 8:00 AM and 4:00 PM 60% of bids occur, and from 4:00 PM to midnight the remaining 20% of bids occur, these percentages are used to weight the bid values from these respective periods.

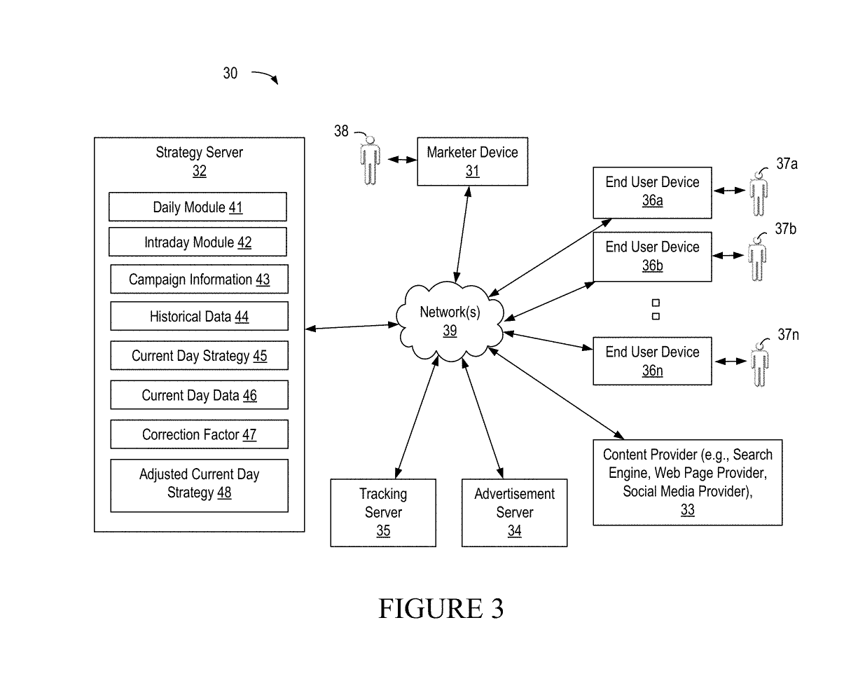

FIG. 3 illustrates an exemplary computer network environment 30 in which an exemplary system provides intraday adjusting. The exemplary computer network environment 30 includes a marketer device 31, a strategy server 32, a content provider 33, an advertisement server 34, a tracking server 35, and end user devices 36a-n. End user device 36a-n are used by end users 37a-n to access electronic content via network 39 from content providers such as content provider 33. A marketer 38 implements a marketing campaign to distribute online ads along with the content that is obtained by the end users 37a-n and viewed (or experienced) on end user devices 36a-n. For example, marketer 38 uses marketer device 31 to create several online ads that are stored on advertisement server 34 and specifies a marketing campaign that is ultimately used to determine how a portfolio budget will be used to pay for placement of the online ads with the electronic content obtained by the end users 37a-n.

The strategy server 32 is used by the marketer 38 to create and implement the marketing campaign. In this example, the strategy server 32 includes a daily module 41, an intraday module 42, campaign information 43, historical data 44, a current day strategy 45, current day data 46, a correction factor 47, and an adjusted current day strategy 48. The campaign information 43 includes information specified by the marketer 38 about the campaign such as portfolio budget, a listing of the online ads, online ad characteristics, parameters for placing online ads, and other such information. The daily module 41 is executed before each day to determine an appropriate daily strategy, i.e., current day strategy 45, for bidding on online ad opportunities during the day. The daily module 41 determines the parameters for allocating a daily budget to online ad opportunities during the current day based on historical data 44 (e.g., prior day's bidding, review, and other results) and the daily portfolio budget. For example, the current day strategy 45 identifies keywords and keyword bid values that will automatically be placed by the strategy server 32 during the current day. The historical data 44 that is used in determining the current day strategy is obtained by tracking server 35. For example, tracking server 35 tracks clicks, costs, user purchases, and other interactions by end users 37a-n resulting from online ads.

The strategy server 32 also includes features that facilitate intraday modeling to adjust the online ad distribution during the current day. Intraday module 42 runs one or more times during the current day. For example, intraday module 42 runs at 8:00 AM and 4:00 PM in one example. Intraday module 42 receives current day data 46 from tracking server 35 including, for example, clicks, costs, user purchases, and other interactions by end users 37a-n resulting from online ads distributed during the current day. The intraday module 42 uses the current day data 45 to determine a correction factor 47 that is applied to current day strategy 45 to provide adjusted current day strategy 48. In one embodiment of the invention, the correction factor 47 is determined by campaign level data and used to adjust bid-specific adjustments. In another embodiment of the invention, determining the adjusted current day strategy 48 involves re-optimizing as discussed herein.

Once the adjusted current day strategy 48 is determined, the strategy server 32 uses the adjusted current day strategy 48 instead of the original (or any other previous) current day strategy 45 to manage and control the distribution of online ads from advertisement server 34 with content from content provider 33. In one example, the adjustment changes the bid amounts that are offered according to the marketing campaign during the rest of the current day for particular keywords used in search engine marketing.

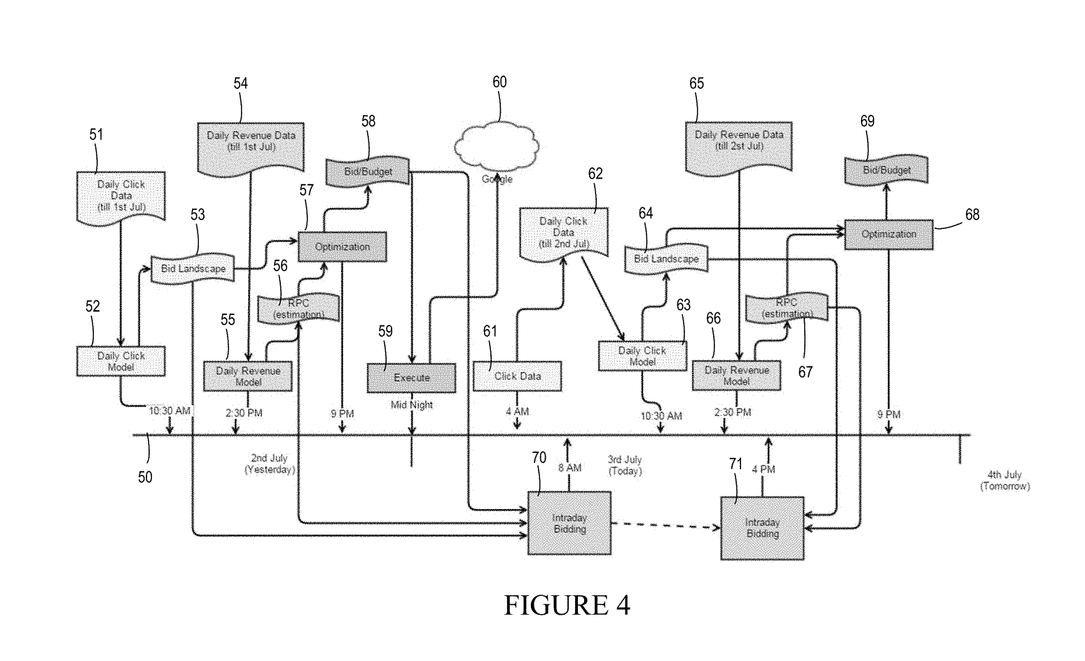

FIG. 4 illustrates an exemplary timeline 50 illustrating an intraday adjustment to a campaign strategy. In this example, daily click data 51 up until a prior date (July 1^{st}) is used to create a daily click model 52 by 10:30 AM on July 2. The daily click model 52 is used to determine a bid landscape 53. Similarly, daily click revenue data 54 up until the prior date (July 1^{st}) is used to create a daily revenue model 55 by 2:30 PM on July 2. The daily review model 55 is also used to provide Revenue per click (“RPC”) estimation 56. The bid landscape 53 and the RPC estimation 56 are used in an optimization 57 run at 9:00 PM on July 2^{nd} to determine bid/budget values 58 for July 3^{rd} that are used by execute module 59 to generate a daily campaign strategy for July 3^{rd} that is implemented via online ad bidding services such as those offered by Google, Inc. of Mountain View, Calif. In this way, the daily campaign strategy is implemented for the early part of July 3^{rd}.

The bid landscape 53, RPC estimate 56, and bid/budget values 58 are also provided for a first intraday bidding process 70 that is run at 8:00 AM on July 3^{rd}. The first intraday bidding process 70 adjusts the implementation of the daily campaign, for example, by adjusting bids for the period of time between 8:00 AM and 4:00 PM of the current day, July 3^{rd}.

The timeline 50 also shows that concurrently with intraday bidding adjustment, daily processes are rerun on July 3 for July 4^{th}. Specifically, click data 62 and daily click data 62 up until a prior date (July 2^{nd}) is used to create a daily click model 63 by 10:30 AM on July 3^{rd}. The daily click model 64 is used to determine a bid landscape 63. Similarly, daily click revenue data 65 up until the prior date (July 2^{nd}) is used to create a daily revenue model 66 by 2:30 PM on July 3^{rd}. The daily review model 66 is also used to provide RPC estimation 67. The bid landscape 64 and the RPC estimation 67 are used in an optimization 68 run at 9:00 PM on July 3^{rd} to determine bid/budget values 69 for July 4^{th} that are used to generate a daily campaign strategy for July 4^{th}. In this way, the daily campaign strategy is implemented for the early part of July 3^{rd}.

The bid landscape 64 and RPC estimate 67 are also provided for a second intraday bidding process that is run at 4:00 PM on July 3^{rd}. The second intraday bidding process 71 adjusts the implementation of the daily campaign, for example, by adjusting bids for the period of time between 4:00 PM and the end of the current day, July 3^{rd}.

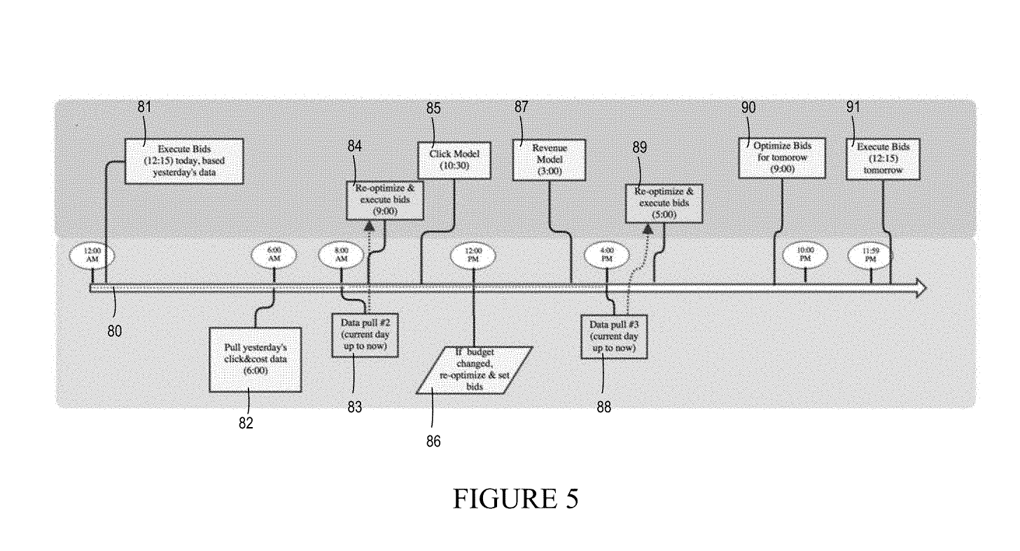

FIG. 5 illustrates another exemplary timeline 80 illustrating an intraday adjustment. In this example, bids are executed by execute bid process that is run at 12:15 AM on the current day based on yesterday's data, as shown in block 81. At 6:00 AM on the current day, yesterday's click and cost data is pulled, as shown in block 82. At 8:00 AM data is pulled for the current day up until the current point in time, as shown in block 83, and at 9:00 AM on the current day, the technique re-optimizes and executes bids, as shown in block 84. At 10:30 AM, as shown in block 85, a click model is determined. At 12:00 noon, if the budget has changed, the process re-optimizes and resets the bids, as shown in block 86. At 3:00 PM, the revenue model is run, as shown in block 87. At 4:00 PM, data is pulled for the current day up until the current point in time, as shown in block 88, and at 5:00 PM, the technique re-optimizes and executes bids, as shown in block 89. At 9:00 PM the process optimizes bids for tomorrow, as shown in block 90. At 12:15 AM on the next day, the bids for tomorrow are executed as shown in block 91.

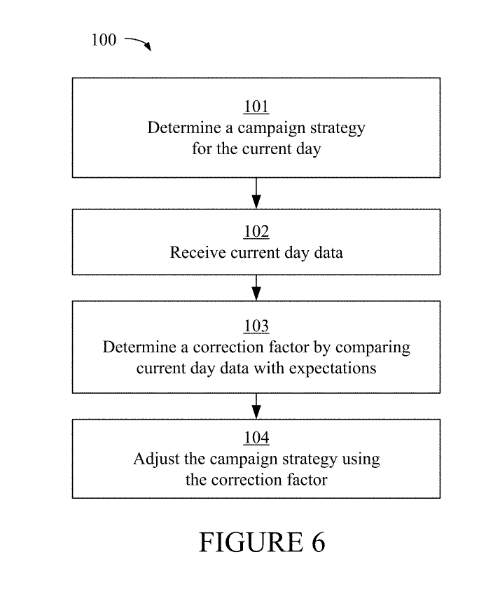

FIG. 6 is a flow chart illustrating an exemplary method 100 for an intraday campaign strategy adjustment. The elements of the method 100 are accomplished using a computing device such as, but not limited to, the computing devices of FIG. 3. This exemplary method 100 first determines a campaign strategy for the current day, as shown in block 101. Such a determination, in one implementation, is run on a daily basis and involves computations, processing, and/or resources such that it is desirable to only need to run the determination once per day. To avoid having to rerun the entire campaign strategy determination, the method 100 makes one or more intraday adjustments. These involve receiving current day data, such as data regarding how much of a budget has been spent so far, how many clicks have been received so far, etc., as shown in block 102. In block 103, a correction factor is determined by comparing the current day data with expectations. For example, if less of the budget has been spent than expected by the daily campaign strategy, a correction factor based on the difference between the actual budget spend and the expected budget spend is determined. In block 104, the method 100 next adjusts the campaign strategy using the correction factor. Such adjustments take various forms depending upon the particular implementation.

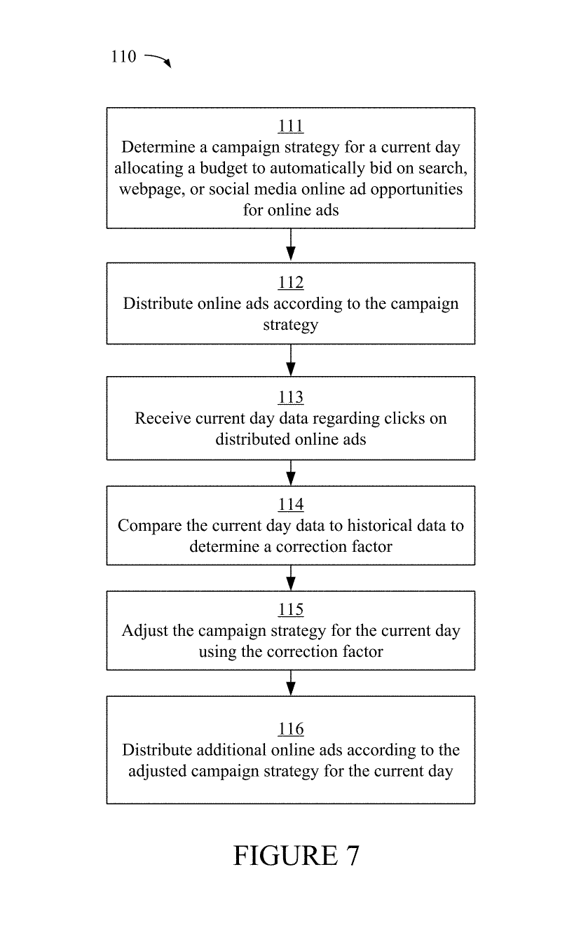

FIG. 7 is a flow chart illustrating an exemplary method 110 for distributing online ads according to an intraday campaign strategy adjustment. The elements of the method 110 are accomplished using a computing device such as, but not limited to, the computing devices of FIG. 3.

In block 111, the method 110 determines a campaign strategy for a current day allocating a daily budget to automatically bid on keyword-based search engine, webpage, or social media online ad opportunities for the online ads using allocated budget amounts. In block 112, the method 110 distributes online ads according to the campaign strategy for the current day.

In block 113, the method 110 receives current day data regarding use (e.g., clicks, purchases, reposts, etc.) of distributed online ads by individuals to whom the online ads were distributed during the early portion of the current day. In block 114, the method 110 compares the current day data to historical data to determine a correction factor. In one embodiment of the invention, the correction factor is determined to accounts for a magnitude of difference between the current day data and the historical data.

In block 115, the method 110 adjusts the campaign strategy for the current day using the correction factor. In one embodiment, this involves adjusting prediction estimates for the current day using the correction factor, for example, adjusting predictions of clicks or cost per clicks predictions. In this example, adjusting the campaign strategy involves using campaign-level click and cost trends and using the trends as proxies for online ad-level trends. For example, a correction factor based on a difference between a current day trend and a historical trend is used to adjust predictions of clicks or cost per clicks for online ads for the current day in one embodiment of the invention.

Adjusting the campaign strategy involves optimizing Return on Investment (ROI) for the campaign strategy in one embodiment of the invention. For example, ROI and/or other parameters are optimized for a remainder of the current day based on a remaining budget for the current day and interpolation of prediction estimates of clicks or cost per clicks for the remainder of the day.

Adjustment to the campaign strategy can additionally or alternatively account for changes to the portfolio budget or other portfolio parameters. For example, adjusting the campaign strategy can involve identifying a new daily budget for the remainder of the day based on identifying a portfolio budget or portfolio composition change for the campaign and then reallocating the new daily budget to automatically bid on keyword-based search engine, webpage, or social media online ad opportunities for the online ads. Thus, in a more comprehensive exemplary embodiment of the invention, adjusting the campaign strategy involves considering a spend amount until a current time, a portfolio budget change, and a portfolio composition change to redistribute a remaining portion of the daily budget to keyword-based search engine, webpage, or social media online ad opportunities for the online ads. Adjusting the campaign strategy can additionally or alternatively involve prioritizing online ad opportunities for the online ads on the basis of relative impact.

In block 116, the method 110 distributes additional online ads with electronic content during a second, later portion of the current day according to the adjusted campaign strategy for the current day.

### Exemplary Computing Environment

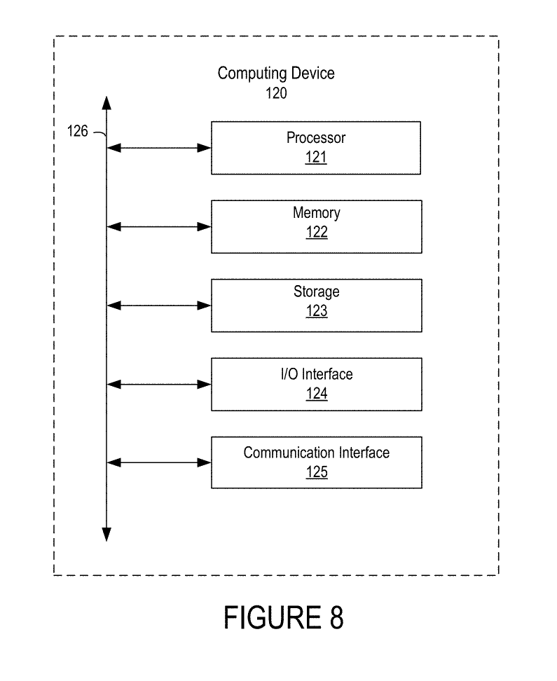

Any suitable computing system or group of computing systems can be used to implement the techniques and methods disclosed herein. For example, FIG. 8 is a block diagram depicting examples of implementations of such components. The computing device 120 can include a processor 121 that is communicatively coupled to a memory 122 and that executes computer-executable program code and/or accesses information stored in memory 122 or storage 123. The processor 121 may comprise a microprocessor, an application-specific integrated circuit (“ASIC”), a state machine, or other processing device. The processor 121 can include one processing device or more than one processing device. Such a processor can include or may be in communication with a computer-readable medium storing instructions that, when executed by the processor 121, cause the processor to perform the operations described herein.

The memory 122 and storage 123 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 120 may also comprise a number of external or internal devices such as input or output devices. For example, the computing device is shown with an input/output (“I/O”) interface 124 that can receive input from input devices or provide output to output devices. A communication interface 125 may also be included in the computing device 120 and can include any device or group of devices suitable for establishing a wired or wireless data connection to one or more data networks. Non-limiting examples of the communication interface 125 include an Ethernet network adapter, a modem, and/or the like. The computing device 120 can transmit messages as electronic or optical signals via the communication interface 125. A bus 126 can also be included to communicatively couple one or more components of the computing device 120.

The computing device 120 can execute program code that configures the processor 121 to perform one or more of the operations described above. The program code can include one or more modules. The program code may be resident in the memory 122, storage 123, or any suitable computer-readable medium and may be executed by the processor 121 or any other suitable processor. In some embodiments, modules can be resident in the memory 122. In additional or alternative embodiments, one or more modules can be resident in a memory that is accessible via a data network, such as a memory accessible to a cloud service.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure the claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method for distributing online ads with electronic content according to a campaign strategy that is adjusted based on intraday modeling, the method comprising:
determining a campaign strategy for a current day, the campaign strategy allocating a daily budget to automatically bid on online ad opportunities for the online ads using allocated budget amounts;
distributing online ads with electronic content during a first portion of the current day according to the campaign strategy for the current day;
receiving current day data regarding use of the distributed online ads by individuals to whom the distributed online ads were distributed during the first portion of the current day;
comparing the current day data to historical data to determine a correction factor that accounts for a magnitude of difference between the current day data and the historical data;
adjusting the campaign strategy for the current day using the correction factor; and
distributing additional online ads with electronic content during a second portion of the current day according to the adjusted campaign strategy for the current day, the second portion of the current day later than the first portion of the current day.

2. The method of claim 1, wherein adjusting the campaign strategy comprises adjusting prediction estimates for the current day using the correction factor.

3. The method of claim 1, wherein adjusting the campaign strategy comprises adjusting predictions of clicks or cost per clicks for online ads for the current day using the correction factor.

4. The method of claim 1, wherein adjusting the campaign strategy comprises using campaign level click and cost trends and using the trends as proxies for ad level trends.

5. The method of claim 1, wherein adjusting the campaign strategy comprises adjusting predictions of clicks or cost per clicks for online ads for the current day using the correction factor, wherein the correction factor is based on a difference between a current day trend and a historical trend.

6. The method of claim 1, wherein adjusting the campaign strategy comprises optimizing Return on Investment (ROI) for the campaign strategy.

7. The method of claim 1, wherein adjusting the campaign strategy comprises optimizing for a remainder of the current day based on a remaining budget for the current day and interpolation of prediction estimates of clicks or cost per clicks for the remainder of the day.

8. The method of claim 1, wherein adjusting the campaign strategy comprises:
identifying a new daily budget for the remainder of the day; and
reallocating the new daily budget to automatically bid on keyword-based search engine, webpage, or social media online ad opportunities for the online ads.

9. The method of claim 1, wherein adjusting the campaign strategy comprises:
identifying a new daily budget for the remainder of the day based on identifying a portfolio budget or portfolio composition change for the campaign; and
reallocating the new daily budget to automatically bid on keyword-based search engine, webpage, or social media online ad opportunities for the online ads.

10. The method of claim 1, wherein adjusting the campaign strategy comprises:
identifying a new daily budget for the remainder of the day;
prioritizing keyword-based search engine, webpage, or social media online ad opportunities for the online ads on the basis of relative impact; and
reallocating the new daily budget to automatically bid on keyword-based search engine, webpage, or social media online ad opportunities for the online ads based on the prioritizing.

11. The method of claim 1, wherein adjusting the campaign strategy comprises considering a spend amount until a current time, a portfolio budget change, and a portfolio composition change to redistribute a remaining portion of the daily budget to keyword-based search engine, webpage, or social media online ad opportunities for the online ads.

12. The method of claim 1 wherein the keyword-based search engine, webpage, or social media online ad opportunities comprise bids, wherein the method further comprises calculating an effective bid from multiple intraday bids for use in a daily click model that receives a single bid for a day for each online ad as input.

13. A method for distributing online ads with electronic content according to a campaign strategy that is adjusted based on intraday modeling, the method comprising:
determining a campaign strategy for a current day allocating a daily budget to automatically bid on online ad opportunities for the online ads using allocated budget amounts;
automatically bidding on online ad opportunities to distribute online ads with electronic content during a first portion of the current day according to the campaign strategy for the current day;
receiving current day data regarding campaign level click and cost trends for the first portion of the current day;
adjusting the campaign strategy for the current day using the campaign level click and cost trends as proxies for ad level trends; and
distributing additional online ads with electronic content during a second portion of the current day according to the adjusted campaign strategy for the current day, the second portion of the current day later than the first portion of the current day.

14. The method of claim 13, wherein adjusting the campaign strategy comprises adjusting prediction estimates for the current day using a correction factor determined using the campaign level click and cost trends.

15. The method of claim 13, wherein adjusting the campaign strategy comprises adjusting predictions of clicks or cost per clicks for online ads for the current day, wherein the correction factor is based on a difference between a current day trend and a historical trend.

16. The method of claim 13, wherein adjusting the campaign strategy comprises optimizing Return on Investment (ROI) for the campaign strategy.

17. The method of claim 13, wherein adjusting the campaign strategy comprises optimizing for a remainder of the current day based on a remaining budget for the current day and interpolation of prediction estimates of clicks or cost per clicks for the remainder of the day.

18. The method of claim 13, wherein adjusting the campaign strategy comprises:
identifying a new daily budget for the remainder of the day based on identifying a portfolio budget or portfolio composition change for the campaign; and
reallocating the new daily budget to automatically bid on keyword-based search engine, webpage, or social media online ad opportunities for the online ads.

19. A system comprising:
a processor for executing instructions stored in computer-readable medium on one or more devices,
a non-transitory computer-readable medium comprising instructions, wherein when executed by the processor, the instructions perform steps comprising:
determining a campaign strategy for a current day allocating a daily budget to automatically bid on online ad opportunities for online ads using allocated budget amounts;
distributing online ads with electronic content during a first portion of the current day according to the campaign strategy for the current day;
receiving current day data regarding use of the distributed online ads by individuals to whom the distributed online ads were distributed during the first portion of the current day;
comparing the current day data to historical data to determine a correction factor that accounts for a magnitude of difference between the current day data and the historical data;
adjusting the campaign strategy for the current day using the correction factor; and
distributing additional online ads with electronic content during a second portion of the current day according to the adjusted campaign strategy for the current day, the second portion of the current day later than the first portion of the current day.

20. The system of claim 19, wherein adjusting the campaign strategy comprises using campaign level click and cost trends and using the trends as proxies for ad level trends.
